(19) United States
(12) Patent Application Publication
(10) Pub. No.: US 2025/0024790 A1
(43) Pub. Date: Jan. 23, 2025

(54) PLANTER MODULE AND MODULAR EXPANDABLE PLANTER SYSTEM

(71) Applicant: MULTY HOME LP, Concord, Ontario (CA)

(72) Inventors: Stevenson TOM, Unionville, Ontario (CA); Ting-Hin YEUNG, Markham, Ontario (CA)

(21) Appl. No.: 18/714,283

(22) PCT Filed: Nov. 28, 2022
(86) PCT No.: PCT/CA2022/051740

§ 371 Date: May 29, 2024

Related U.S. Application Data
(60) Provisional application No. 63/284,001, filed on Nov. 29, 2021.

(51) Int. Cl. A01G 9/02; A01G 27/06

(52) U.S. Cl. CPC A01G 9/023; A01G 9/027; A01G 27/06

(57) ABSTRACT

A planter module and an expandable modular planter system for both indoor and outdoor use. The planter modules are configured to maintain adequate moisture/water and are substantially hexagonally shaped permitting substantially close adjacent positioning and connection between planter modules to form a modular planter system in a honeycomb pattern. The modular planter system is reconfigurable both horizontally and vertically.

### FIELD OF THE INVENTION

The present invention relates to a planter module and modular expandable planter system incorporating the planter module that may be used both indoors and outdoors for planting. The modular expandable planter system is reconfigurable and repositionable as desired.

### BACKGROUND OF THE INVENTION

Horticultural therapy is simply stated as well being derived from working in a garden and working with plants. Gardens and greenhouses are very soothing places that are good for mental outlook. For such reasons more people are turning to gardening as a friendly healthy hobby and/or for a means to grow certain crops as a source of food.

People living in the city often have smaller living spaces and thus require a more space-conscious approach for gardening turning to a planter-based system for a small yard, porch, patio or balcony. Planter-based gardening may be used to grow edible plants or flowers and is esthetically pleasing and decorative. Many types of planters exist and some are designed to alleviate limited space requirements or to provide a way to grow plants when open space and soil is not available. Some planters arrange plants in towers or other vertical arrangements. Multi-tier, stackable planters comprised of stackable units have been shown capable of holding multiple plants at a periphery of the planter units, however, are often unstable and thus may not be safe. They require fasteners with respect to individual components as well as to affix to a vertical support structure. Once assembled, they are difficult to move and their configuration is often unchangeable.

It is desirable to provide a modular, stackable planter system that addresses these needs and other deficiencies in prior art planters.

### SUMMARY OF THE INVENTION

The present invention improves upon conventional planter systems by providing a planter module that can be used as a stand alone planter or can be incorporated as part of a modular planter system incorporating a plurality of planter module(s). The modular system is versatile with respect to configuration and size, for example planter modules can be releasably connected to adjacent planter modules in a secure and stable manner and presented as a single level garden bed, double level garden bed or higher level garden bed whereby the planter modules are arranged substantially adjacent contact and further can be stacked and reversibly connected to adjacent planter modules. A garden bed comprising a modular planter system can be expanded horizontally to cover a larger surface area and/or vertically. Furthermore, whether used as a stand alone planter or as a single level or higher level modular planter system the planter module(s) can be raised such that the first level is not in direct contact with a ground surface.

The configurations of a modular planter system permits planting of segmented garden bed(s) or mixed garden bed(s) as desired. The planter module and modular planter system is suitable for planting and growing any variety of planting and growing needs and is not limited, e.g. any type of flower, vegetable, fruit, herb, bush, tree and the like can be grown in the planter module and system described herein. The planter module and modular planter system is provided herein for both indoor and outdoor use and may be used in both residential and commercial settings.

Advantageously, each planter module is configured such that one planter module can releasably but securely and stably connect with three other planter modules without requiring any fasteners or the like. Thus large modular stable structures can be assembled, disassembled and reassembled quickly and efficiently requiring no fasteners or tools. This allows for the planter module and modular systems to be moved to any desired location and also simplifies storage.

The planter module and system is universally configurable, for example: physically configurable with respect to dimensions of each planter module (width (wide), depth (deep), and height): functionally configurable with respect to singular planter module for ‘simple’ decorative planting, multiple broad layout for urban gardening, linear layout for space definition and/or decorative planting: multiple stacked layout for vertical gardening/green wall builds; and raised by adding legs creating a raised garden bed or decorative garden layout (for indoors and/or outdoors).

Planter modules and systems described herein fit naturally together requiring no extra components or parts/fasteners or tools but instead use a high efficiency reversible fit such that there is a minimal loss of gardening area with addition of extra planter units. The fit assembly is highly stable due to the deep configuration/engagement when stacking providing superior stability and safety.

Furthermore, planter modules are configured to maintain moisture/water such that water does not simply drain out, but rather is collected in compartment(s) located in a base portion of the planter module. The means to maintain moisture/water also comprises a mechanism to plug and prevent water/moisture from escaping as well as overflow drainhole(s) for self-draining excess water.

Planter modules and systems described herein have a high aesthetic presence. In one embodiment the planter module is substantially a hexagonally shaped cylinder such that systems comprising a plurality of adjacently arranged and/or connected planter modules form a honeycomb pattern which is found in nature. The systems of hexagonal planter modules of the present invention provide optimum space usage and may be configured for a number of different uses.

While the hexagonal shape is one desired embodiment, permitting substantially close adjacent positioning and connection between planter modules and therefore a more stable and esthetically pleasing garden bed other shapes are within the scope of the invention. For example, the planter module can be shaped as a triangle, circle, semi-circle, square, rectangle, parallelogram, rhombus, trapezium, kite and various other polygons (e.g. pentagon, hexagon, octagon, nonagon, decagon, and so forth). The shape can be varied so long as the connection means between planter modules is maintained, the addition of reversibly connected legs to form a raised garden bed is maintained, and the moisture/water can be maintained as for the hexagonal system described herein.

The planter module(s) and systems described herein can be customizable to any color, blended with UV-12 inhibitors to protect color, decorated further with a desired logo, icon, or finish, are weather resistant, substantially maintenance free, easy to clean as needed, have some degree of flexibility enough to absorb impact without damage, easy to move, substantially non-porous and non-hydroscopic, impervious to water damage, rust and insects, and can support and is safe for plantings with various mulches and soils therein.

The planter module described herein can be fabricated from thermoplastic polymers, resins, elastomers and mixtures thereof. The planter module can be injected molded from compositions comprising plastic, recycled plastic, recycled crumb rubber and mixtures thereof. In aspects recycled rubber, adds durability and all-weather resistance in both hot and cold seasons.

In one aspect, a planter module or modular planter system described herein may be used as a complete system or as individual components for providing landscape elements, such as terracing, borders, a tree ring-guard, a freestanding structure, mailbox base, for decoration or concealment of posts, hydrants, property markers, etc.

The planter may be used to safely grow a variety of plants, including herbs, flowers, strawberries, ground covers, cactus, etc.

According to an aspect of the invention is a planter module configured for receiving soil and plants planted therein, said planter module comprising an open top portion and a lower base portion, wherein said lower base portion comprises a dual means for releasable fitted connection with at least one other adjacent modular planter and for receiving and securely connecting support legs around the periphery of the lower base portion. The planter module optionally comprises a water reservoir in the lower base portion.

According to an aspect of the invention is a self watering planter module configured for receiving soil and plants planted therein, said planter module comprising an open top portion and a lower base portion, wherein said lower base portion comprises reversibly connected support legs around the periphery of the lower base portion.

According to an aspect of the invention is a planter module comprising:
a body comprising an open top portion and a lower base portion, the lower base portion having a diameter smaller than an inner diameter of the upper open top portion,
wherein said lower base portion comprises means for releasable fitted connection with at least one other adjacent modular planter, said means is further configured for reversibly receiving and support legs around the periphery of the lower base portion, and optionally wherein said lower base portion is configured for collecting water.

In aspects, the lower base portion of a planter module is configured to securely engage and interconnect the three other planter modules.

A single layer garden bed comprising a plurality of planter modules, each of said planter modules comprising:
a body comprising an open top portion and a lower base portion having a diameter smaller than an inner diameter of the upper open top portion,
wherein said lower base portion is configured for collecting water,
wherein said lower base portion comprises means for releasable connection with at least one other adjacent modular planter, said means is further configured for reversibly receiving and support legs around the periphery of the lower base portion, and
wherein said planter modules are arranged in a honeycomb shape.

According to an aspect of the invention is a kit for assembling a modular expandable planter system, comprising a plurality of planter modules, each of said planter modules comprising:
a body comprising an open top portion and a lower base portion having a diameter smaller than an inner diameter of the upper open top portion,
wherein said lower base portion is configured for collecting water,
wherein said lower base portion comprises means for releasable connection with at least one other adjacent modular planter, said means is further configured for reversibly receiving and support legs around the periphery of the lower base portion.

In aspects the kit further comprises a plurality of support legs for attachment to the lower base portion, and optional instructions.

### Aspects of the Invention:

1. A planter module comprising:
   a body comprising an open top portion and a lower base portion, the lower base portion having a diameter smaller than an inner diameter of the upper open top portion, and
   wherein said lower base portion comprises means for reversible connection to an upper side wall of up to three other modular planters.
2. The planter module of claim 1, wherein said means for reversible connection comprises a Y-shaped channel system.
3. The planter module of claim 2, further wherein said Y-shaped channel system is further configured for reversibly receiving support legs around a periphery of the lower base portion.
4. The planter module of claim 2 or 3, wherein said Y-shaped channel system partitions the lower base portion into separate reservoirs.
5. The planter module of claim 4, wherein the separate reservoirs are configured for collecting and draining water.
6. The planter module of any one of claims 2 to 5, further comprising a reservoir insert shaped to fit and be supported on a ledge formed by said Y-shaped channel system.
7. The planter module of claim 6, wherein the reservoir insert is a substantially flat perforated tray comprising downwardly projecting drainage cups into each of said reservoirs.
8. The planter module of claim 7, wherein each of said downwardly projecting cups have sidewalls comprising openings for movement of water therethrough.
9. The planter module of claim 6, 7 or 8, wherein the reservoir insert functions to separate water from soil and allow for plant roots and/or the soil to wick water from each of the compartments.
10. The planter module of any one of claims 4 to 9, wherein one or more of the separate reservoirs comprises a pluggable drainage hole.
11. The planter module of claim 10, wherein the drainage hole prevents overflow of water.
12. The planter module of any one of claims 1 to 11, wherein said modular planter is integrally formed.
13. The planter module of claim 12, wherein said modular planter is made by injection molding, double injection molding, over-molding, gas-assisted molding or microcellular injection molding.
14. The planter module of any one of claims 1 to 11, wherein said modular planter is formed from parts.
15. The planter module of any one of claims 1 to 14, comprising plastic, wood and/or metal, optionally one or more of the plastic, wood and metal is from a recycled source.
16. The planter module of claim 15, comprising polyethylene, polypropylene, polystyrene polybutene, polyisoprene, polypentene and mixtures thereof.
17. The planter module of claim 16, further comprising crumb rubber comprising a synthetic rubber selected from styrene-butadiene rubber, ethylene propylene diene rubber, ethylene propylene rubber (EPR), butadiene rubber (BR) and mixtures thereof.
18. The planter module of any one of claims 1 to 17, further comprising an ultraviolet radiation inhibitor.
19. The planter module of any one of claims 1 to 18, further comprising up to about 10% by weight additives selected from the group consisting of titanium dioxide, UV stabilizers, calcium carbonate, talc, flame retardants and combinations thereof.
20. The planter module of any one of claims 1 to 18, further comprising up to about 10% by weight colorant.
21. A planter module comprising:
   a body comprising an open top portion and a lower base portion, the lower base portion having a diameter smaller than an inner diameter of the upper open top portion, and
   wherein said lower base portion comprises a Y-shaped channel system with reversibly connected support legs around a periphery of the lower base portion.
22. The planter module of any one of claims 1 to 21, wherein the planter module is hexagonally shaped.
23. A single layer garden bed comprising a plurality of the planter module of any one of claims 1 to 22, wherein said garden bed comprises a honeycomb arrangement.
24. A multilevel garden bed comprising a plurality of the planter module of any one of claims 1 to 22, wherein each raised level of said multilevel garden bed comprises a honeycomb arrangement that is offset with respect to a honeycomb arrangement in a lower level.
25. A kit for assembling a modular expandable planter system, comprising a plurality of planter modules, each of said planter modules comprising:
   a body comprising an open top portion and a lower base portion having a diameter smaller than an inner diameter of the upper open top portion, wherein said lower base portion is configured for collecting water,
   wherein said lower base portion comprises means for releasable connection with at least one other adjacent modular planter, said means is further configured for reversibly receiving and support legs around the periphery of the lower base portion.
26. The kit of claim 25, further comprising a plurality of support legs for attachment to the lower base portion, and optional instructions.
27. The kit of claim 25 or 26, further comprising a reservoir insert shaped to fit and be supported within the lower base portion.
28. A hexagonal planter module comprising:
   a body comprising an open top portion and a lower base portion having a diameter smaller than an inner diameter of the upper open top portion, wherein said lower base portion is configured for regulating water,
   wherein said lower base portion comprises means for releasable connection with at least one other adjacent modular planter, said means is further configured for reversibly receiving and support legs around the periphery of the lower base portion.

The features, functions, and advantages that have been discussed can be achieved independently in various embodiments of the present disclosure or may be combined in yet other embodiments. Other features, functions and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon illustrating the principles of the present disclosure. Moreover, in the drawings, like reference numerals designate corresponding parts throughout the several views:

FIG. 1 shows a planter module in accordance with an embodiment of the invention;

FIG. 2 is a bottom perspective view of the planter module:

FIG. 2A is a transparent portion of the planter module of FIGS. 1 and 2 showing the lower base portion compartments:

FIG. 3 shows a single level garden bed formed from a plurality of adjacently arranged planter modules forming a honeycomb shape:

FIG. 4 shows an embodiment of a configuration of a double level garden bed, where the second level is raised and mounted to the top of the first level:

FIG. 5 shows a further embodiment of a configuration of a double level garden bed:

FIG. 6 shows a further embodiment of a configuration of a double level garden bed:

FIG. 7 shows a further embodiment of a configuration of a double level garden bed:

FIG. 8 shows an expanded view of the planter module of FIG. 1 with legs configured for slidable secure connection to the lower base portion of the planter module:

FIG. 9 shows an expanded bottom perspective view of FIG. 8, arrows showing the channels and positioning of each leg rail to slidably engage in a channel:

FIG. 10 shows an embodiment of a configuration a single level raised garden bed formed from a plurality of adjacently arranged planter modules forming a honeycomb shape:

FIG. 11 shows a bottom perspective view of the embodiment of FIG. 10:

FIG. 12 shows an embodiment of a configuration of a double level garden bed, where the first level is raised with legs and the second level is raised by mounting to the top of the first level:

FIG. 13 shows an expanded view of a reservoir insert and planter module, the reservoir insert being shaped to fit and sit within the lower base portion of the planter module:

FIG. 14 is a view of FIG. 13 the planter module is transparent to more closely show the corresponding fit of the reservoir insert within the lower base portion of the planter module:

FIG. 15 is a further view of FIG. 14, showing the plate-like configuration of the reservoir insert with open cup shaped protrusions extending towards the closed lower base portion for water retention and wicking, the reservoir insert supported sitting on the ceiling portions of the channels within the planter module:

FIG. 16 is a top plan view of FIG. 15, showing the perforations within the top structure, the shape of the reservoir insert matching the shape of the inside periphery of the lower base portion of the planter module; and

FIG. 17 is a cross sectional view taken through line A of FIG. 15 more closely showing the configuration of the open cup shaped protrusions and the drain hole.

### DESCRIPTION OF THE INVENTION

All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting.

Unless defined otherwise, all technical terms used herein have the same meaning as commonly understood by one of ordinary skill in the art to which the invention pertains. Although any methods and materials similar or equivalent to those described herein can be used in the practice for testing of the present invention, the typical materials and methods are described herein.

It is also to be understood that the terminology used herein is for the purpose of describing particular aspects only, and is not intended to be limiting.

The articles “a” and “an” are used herein to refer to one or to more than one (i.e., to at least one) of the grammatical object of the article. By way of example, “an element” means one element or more than one element.

As used herein, the terms “invention” or “present invention” are non-limiting terms and not intended to refer to any single aspect of the particular invention but encompass all possible aspects as described in the specification and the claims.

As used herein the terms ‘comprises’, ‘comprising’, ‘includes’, ‘including’, ‘having’ and their inflections and conjugates denote ‘including but not limited to’ and are to be understood to be open-ended, e.g., to mean including but not limited to.

As used herein, the term “about” refers to variation in the numerical quantity. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

Should a range of values be recited, it is merely for convenience or brevity and includes all the possible sub-ranges as well as individual numerical values within and about the boundary of that range. Any numeric value, unless otherwise specified, includes also practical close values and integral values do not exclude fractional values. Sub-range values and practically close values should be considered as specifically disclosed values.

It will be understood that any component defined herein as being included may be explicitly excluded from the claimed invention by way of proviso or negative limitation.

As may be used herein, the terms ‘preferred’, ‘preferably’, ‘typical’, ‘typically’ or ‘optionally’ do not limit the scope of the invention or embodiments thereof.

As may be used herein the term ‘substantially’ (or synonyms thereof) denote with respect to the context a measure or extent or amount or degree that encompass a large part or most of a referenced entity, or an extent at least moderately or much greater or larger or more effective or more important relative to a referenced entity or with respect to the referenced subject matter.

As used herein the term ‘may’ denotes an option or an effect which is either or not included and/or used and/or implemented and/or occurs, yet the option constitutes at least a part of some embodiments of the invention or consequence thereof, without limiting the scope of the invention.

The phrase “and/or,” as used herein in the specification and in the claims, should be understood to mean “either or both” of the elements so conjoined, e.g., elements that are conjunctively present in some cases and disjunctively present in other cases. Other elements may optionally be present other than the elements specifically identified by the “and/or” clause, whether related or unrelated to those elements specifically identified unless clearly indicated to the contrary.

As used herein in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. In general, the term “or” as used herein shall only be interpreted as indicating exclusive alternatives (e.g. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein “a plurality” is understood to be any number greater than one. “Plurality” means “two or more”.

As used herein “garden bed” is understood to be intentional plant placement within a defined area that is typically compact.

As used herein a “raised garden bed” is a form of gardening in which the soil is enclosed in a containment unit (“bed”) and where the soil is raised above the surrounding soil/ground. The containment unit as described herein in accordance with the invention is a planter module.

It should also be understood that, unless clearly indicated to the contrary, in any methods claimed herein that include more than one step or act, the order of the steps or acts of the method is not necessarily limited to the order in which the steps or acts of the method are recited.

The following description provides an overview and description of non-limiting embodiments of a planter module constructed in accordance with the present invention. While illustrative examples are described herein, these examples are not intended to be exhaustive or to limit the invention to the precise forms disclosed. Similarly, any process steps described herein, e.g., for assembling or configuring an embodiment of the present invention, may be interchangeable with other steps, or several combinations of steps, in order to achieve the benefits and advantages of the invention.

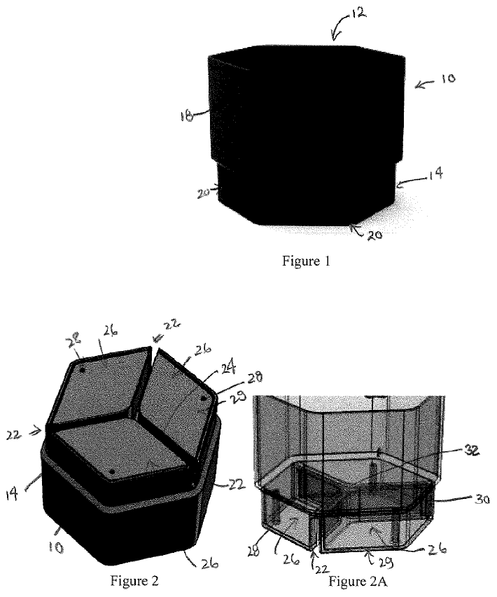

Referring now to FIG. 1 is shown a planter module 10 in accordance with an embodiment of the invention. The planter module is shown as having a unitary body 12 comprising an open top portion 14 and a lower base portion 16 with a closed bottom. The planter module for receiving dirt (e.g. soils and the like, and plants and the like). The lower base portion 16 has a smaller diameter than the open top portion 14 thus a portion of open top portion extends over around the entire periphery of the lower base portion (is wider around). The body is hexagonal shaped with six upper side walls 18 and six lower side walls 20. The upper side walls 18 and the lower side walls 20 are substantially parallel. The lower base portion comprises channel openings 22 about the perimeter of the lower base portion which merge centrally and which depth extends substantially the entire width of the lower base portion. The open top portion is for adding the soil and plants.

FIG. 2 is a bottom perspective view of the planter module 10 better illustrating the channel openings 22 which lead to an interconnected Y-shaped deep upwardly facing outwardly extending channel system 24 that partitions/divides the lower base portion into separate compartments/reservoirs 26. A drain hole 28 is provided in each compartment/reservoir floor 29 of the lower base portion. FIG. 2A is a transparent view to better show the separate compartments/reservoirs. The channel system ceiling 30 forms a Y-shaped ledge 32 at the boundary between the open top portion 14 and the lower base portion 16. The drainage holes are shown as open upwardly extending tubular projections that are shorter than the Y-shaped ledge. It is understood that additional drain hole(s) can be provided.

It is understood by one skilled in the art that the planter module can be made of any desired height and diameter with a desired thickness of sidewalls. A representative planter module is about 16″×about 14″ (flat to flat)×about 12″ tall (about 21″ tall w/legs). The thickness of the sidewalls is only limited by the width of the channel system, for example about 0.25 inches thick.

FIG. 3 shows one embodiment of a modular expandable planter system 100 having several planter modules 110 closely arranged to form a honeycomb pattern as a single layer garden bed where the planter modules 110 are not connected to each other.

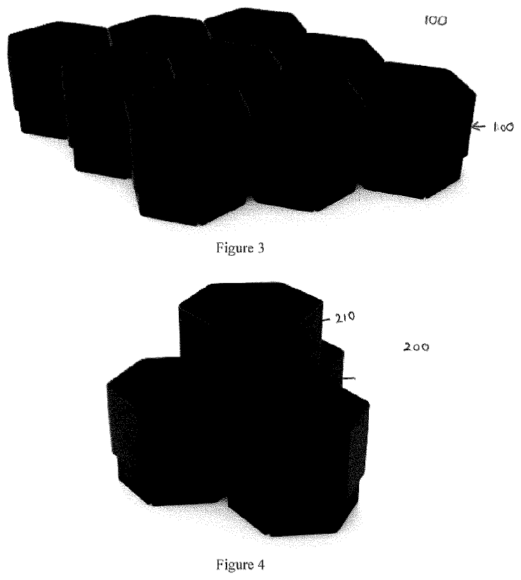

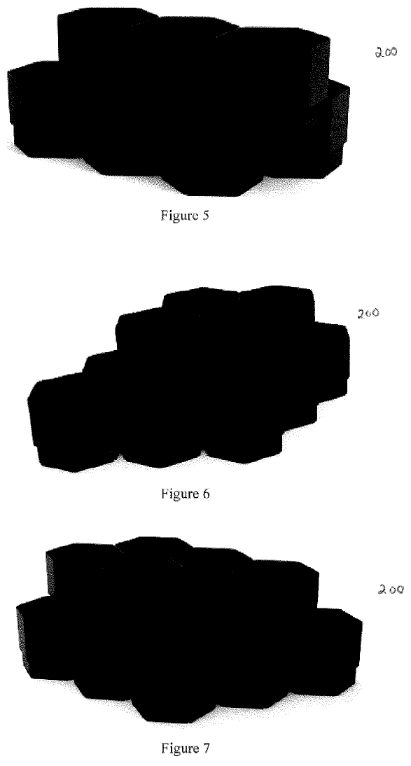

FIG. 4 shows a further embodiment of a modular expandable planter system 200 comprising a single layer garden bed with an upper planter module 210 stacked and secured thereon in a staggered fashion by aligning the Y-shaped channel system of the lower base portion of the upper planter module over top and with three adjacent planter module side walls positioned underneath, whereby downward force of the upper planter module causes engagement of the adjacent upper wall edges of each lower adjacent planter module to slidingly and tightly engage within the Y-shaped channel system of the upper planter module. The depth of the Y-shaped channel system creates a secure fit and a stable configuration. FIGS. 5-7 show various embodiments of a modular expandable planter system comprising a second level of securely interconnected hexagonal planter modules on a first level of honeycomb arranged planter modules. The configuration is a natural best fit and is esthetically pleasing.

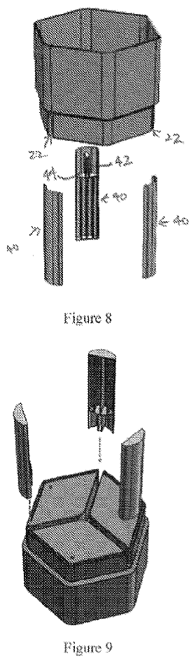

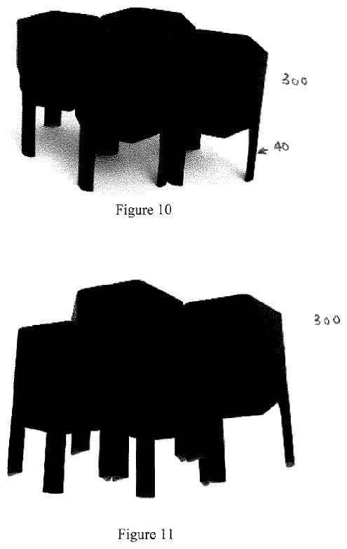

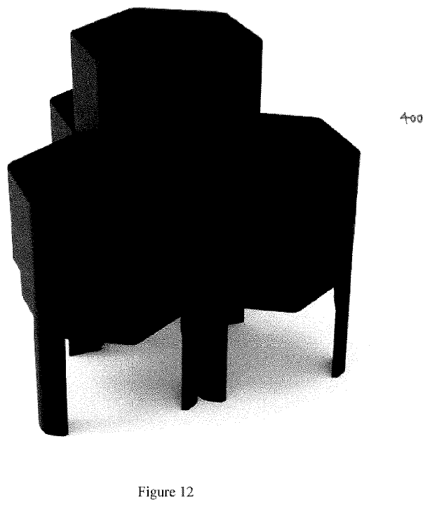

FIG. 8 shows how leg portions 40 are positioned to reversibly fit within the channel openings 22. The leg portions 40 comprise a elongated leg rail 42 ending with a stop shoulder 44. FIG. 9 is a bottom perspective view that shows how the elongated leg rail 42 is positioned to slidingly engage within the channel openings until the stop shoulder 44 is reached. This about corresponds to the width of the lower base portion and forms a close stable fit. A leg portion is inserted at each channel opening. FIGS. 10 and 11 show a raised single layer garden bed 300 comprising several planter modules closely arranged to form a honeycomb pattern but where the planter modules are not connected to each other. The leg portions are shaped to be substantially flush with the side walls of the open top portion of the body. The foot of the leg portion also closely fits with corresponding feet of adjacent planter modules. In this manner the planter modules can be closely and tightly arranged for a better esthetic look.

FIG. 12 shows a further embodiment of a modular expandable planter system 400 comprising a two layer garden bed, where the first garden bed layer is raised with connected leg portions. The upper planter module is stacked onto and secures together (via the lower base portion) the three lower planter modules by engagement of the adjacent upper wall edges of each lower adjacent planter within the deep Y-shaped channel system as it is downwardly slid thereon to tightly engage. The second layer is offset from the first layer of planters, which provides for a secure configuration and still allows for an adequate opening to add soil and plants to each of the planter modules.

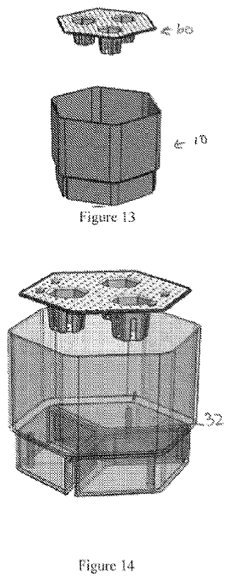

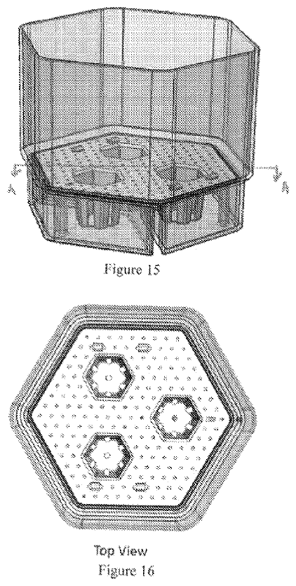

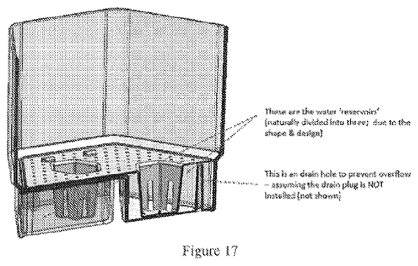

FIGS. 13 and 14 show a reservoir insert 60 that is shaped to fit supported within the planter module and rest on the Y-shaped ledge 32 at the boundary between the open top portion 14 and the lower base portion 16, at the top of the formed reservoirs. The reservoir insert 60 is readily removable and is shaped to correspond to the shape of the inner periphery of the lower base portion of the body. The reservoir insert 60 is a substantially flat perforated tray further comprising open downwardly projecting drainage cups, one in each of the compartments. The side walls of the downwardly projecting cups have openings, vertical slits better seen in FIGS. 15 to 17. The reservoir insert functions to separate water from the soil and allow roots and/or soil to wick water from each of the compartments. In FIGS. 15 and 17 the drain holes are seen as open ended upward projections, the open end does not contact the lower face of the reservoir insert. In this manner the planter module is self-watering. Should the water level in any of the compartments rise to reach the top of the open end of the drain hole projection, the water will simply drain away through the hole. The drain holes can be plugged with any means of stopper (not shown). In this manner any excess water from watering or rain, will fill the compartments and be wicked in through the vertical slits in the downwardly projecting cups through the soil and reaching roots of the plants. As seen in FIG. 16, the reservoir insert is perforated throughout. While the openings to the drainage cups is shown hexagonal, it can be of any shape desired.

The reservoir insert can be made of any desired plastic such as for example high density polyethylene (HDPE) by injection molding forming a unitary body.

### Fabrication

The physical composition and construction of the planter modules provides unique durability and expandability. They may be constructed of plastic, such as polyethylene, in aspects high density polyethylene (HDPE). However, other materials are also contemplated including metals, polypropylene and polystyrene. Although high density polyethylene is desired, the use of low density polyethylene, linear low density polyethylene and mixtures of high density/low density polyethylene are also contemplated as is linear low density polyethylene (LLDPE)

The planter modules are each one piece articles formed by standard injection molding procedures well known in the art. Briefly, in one aspect high density polyethylene is melted, injected into a mold, allowed to cool and removed from the mold.

The material of construction may be enhanced using ultraviolet radiation inhibitors to improve durability and retention of physical characteristics such as color and surface texture as well as a strengthening filler as desired.

The walls of the planter module are strong and not capable of any significant flexing. In particular, the wall panels cannot be flexed to form a curved configuration. On the contrary, the walls provide rigid and flat planar surfaces as a polygonal planter. As opposed to planters comprising more flexible and fragile material construction, the present modular panel construction promotes interconnecting of planter units into preferred arrangements.

Again, the planter module and reservoir insert may be made by example by injection molding and may or may not include any integrated parts or components using a wide range of thermoplastic polymers, resins and elastomers. They can be injected molded from compositions comprising plastic, recycled plastic, recycled crumb rubber and mixtures thereof. Briefly in one aspect, injection molded planter modules may be generally made by pouring a raw plastic composition into a hopper, then heating injecting it into a custom mold. Pressure is used accommodate shrinkage and once the plastic molded planter has fully cooled, the mold is opened, and the planter module removed. Planter modules of the invention can be also made incorporating techniques of over-molding and insert molding.

In aspects, the planter modules of the invention are made from a suitable polyolefin selected from the group consisting of polyethylene, polypropylene, polybutene, polyisoprene, polypentene and mixtures thereof. In aspects the polyolefin is polyethylene or polypropylene. The polyolefin can be from a recycled source.

In other aspects the polyolefin can further comprise admixed particles of crumb rubber to form a mixture for injection molding. In aspects, the crumb rubber can comprise a synthetic rubber selected from styrene-butadiene rubber (SBR—a copolymer of styrene and butadiene), ethylene propylene diene rubber (EPDM—a terpolymer of ethylene, propylene and a diene-component), ethylene propylene rubber (EPR), butadiene rubber (BR) and mixtures thereof. Any rubber source can be of a recycled nature. When heated at temperatures of about 140° C. to about 230° C., inclusive of any specific temperature in between, the polyolefin will melt about the crumb rubber. The amount of crumb rubber to polyolefin used in the composition for injection molding a planter module is understood by one of skill in the art to range and can be up to about 25% by weight.

Up to about 10% by weight additives can be incorporated into the composition for injection molding as desired to improve and/or alter certain properties of the end product, as would be understood by a skilled person. These are selected from the group consisting of titanium dioxide, UV stabilizers, calcium carbonate, talc, flame retardants and combinations thereof. It is also understood that in embodiments of the invention, no additives are incorporated. Up to about 10% by weight colorant can be incorporated into the composition for injection molding as desired. It is also understood that in embodiments of the invention, no colorants may be incorporated.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention as defined by the claims.

We claim:

1.-28. (canceled)

29. A planter module comprising:
a body comprising an open top portion and a lower base portion, the lower base portion having a diameter smaller than an inner diameter of the upper open top portion, and
wherein the lower base portion comprises means for reversible connection to an upper side wall of up to three other modular planters.

30. The planter module of claim 29, wherein the means for reversible connection comprises a Y-shaped channel system.

31. The planter module of claim 30, wherein the Y-shaped channel system is further configured for reversibly receiving support legs around a periphery of the lower base portion.

32. The planter module of claim 30, wherein the Y-shaped channel system partitions the lower base portion into separate reservoirs, wherein the separate reservoirs are configured for collecting and draining water.

33. The planter module of claim 30, further comprising a reservoir insert shaped to fit and be supported on a ledge formed by the Y-shaped channel system.

34. The planter module of claim 33, wherein the reservoir insert is a substantially flat perforated tray comprising downwardly projecting drainage cups into each of the reservoirs.

35. The planter module of claim 34, wherein each of the downwardly projecting cups have sidewalls comprising openings for movement of water therethrough.

36. The planter module of claim 33, wherein the reservoir insert functions to separate water from soil and allow for plant roots and/or the soil to wick water from each of the compartments.

37. The planter module of claim 32, wherein one or more of the separate reservoirs comprises a pluggable drainage hole, wherein the drainage hole prevents overflow of water.

38. The planter module of claim 29, wherein the modular planter is integrally formed or formed from parts.

39. The planter module of claim 38, wherein the modular planter is made by injection molding, double injection molding, over-molding, gas-assisted molding or microcellular injection molding.

40. The planter module of claim 29, wherein the planter comprises plastic, wood and/or metal, optionally one or more of the plastic, wood and metal is from a recycled source.

41. The planter module of claim 40, comprising polyethylene, polypropylene, polystyrene polybutene, polyisoprene, polypentene, and mixtures thereof.

42. The planter module of claim 41, further comprising crumb rubber comprising a synthetic rubber selected from styrene-butadiene rubber, ethylene propylene diene rubber, ethylene propylene rubber (EPR), butadiene rubber (BR) and mixtures thereof.

43. The planter module of claim 40, further comprising:
an ultraviolet radiation inhibitor; and/or
up to about 10% by weight additives selected from the group consisting of titanium dioxide, UV stabilizers, calcium carbonate, talc, flame retardants and combinations thereof; and/or
up to about 10% by weight colorant.

44. The planter module of claim 29, wherein the planter module is hexagonally shaped.

45. A single layer garden bed comprising a honeycomb arrangement of a plurality of the planter modules of claim 29.

46. A multilevel garden bed comprising a plurality of the planter modules of claim 29, wherein each raised level of the multilevel garden bed comprises a honeycomb arrangement that is offset with respect to a honeycomb arrangement in a lower level.

47. A kit for assembling a modular expandable planter system, comprising a plurality of planter modules, each of the planter modules comprising:
a body comprising an open top portion and a lower base portion having a diameter smaller than an inner diameter of the upper open top portion,
wherein the lower base portion is configured for collecting water,
wherein the lower base portion comprises means for releasable connection with at least one other adjacent modular planter, the means is further configured for reversibly receiving and support legs around the periphery of the lower base portion.

48. The kit of claim 47, further comprising:
a plurality of support legs for attachment to the lower base portion, and optional instructions; and/or
a reservoir insert shaped to fit and be supported within the lower base portion.
